(19) United States
(12) Patent Application Publication
(10) Pub. No.: US 2023/0274466 A1
(43) Pub. Date: Aug. 31, 2023

(54) POINT CLOUD POLAR COORDINATE CODING METHOD AND DEVICE

(71) Applicant: QUANZHOU EQUIPMENT MANUFACTURING RESEARCH INSTITUTE, Jinjiang (CN)

(72) Inventors: Xian WEI, Jinjiang (CN); Jielong GUO, Jinjiang (CN); Hui YU, Jinjiang (CN); Xuan TANG, Jinjiang (CN); Hai LAN, Jinjiang (CN); Jianfeng ZHANG, Jinjiang (CN); Yufang XIE, Jinjiang (CN); Dongheng SHAO, Jinjiang (CN); Chao LI, Jinjiang (CN)

(21) Appl. No.: 18/313,685

(22) Filed: May 8, 2023

Related U.S. Application Data
(63) Continuation of application No. PCT/CN2021/096328, filed on May 27, 2021.

(30) Foreign Application Priority Data
Feb. 5, 2021 (CN) . 202110164107X

(51) Int. Cl. G06T 9/00; G06V 10/77; G06V 10/82

(52) U.S. Cl. CPC G06T 9/001; G06V 10/7715; G06V 10/82

(57) ABSTRACT

Disclosed are a point cloud polar coordinate coding method and a device, including dividing a circular scanning area scanned by a lidar at an equal angle with an angle Δθ to obtain a plurality of identical polar coordinate areas; dividing each of the polar coordinate areas with equal length along a radial direction with a length Δr to obtain a plurality of polar coordinate grids and generating a plurality of polar coordinate cylinders corresponding to each of the polar coordinate grids in a three-dimensional space; generating polar coordinate cylinder voxels; extracting structural features from the all point cloud data in each of the polar coordinate cylinder voxels; obtaining a two-dimensional point cloud pseudo-image; boundary supplementing to the two-dimensional point cloud pseudo-image; and performing feature extraction on the two-dimensional point cloud pseudo-image by using convolutional neural networks, and outputting a final feature map.

### CROSS-REFERENCE TO RELATED APPLICATIONS

This application is a continuation of PCT/CN2021/096328, filed on May 27, 2021, and claims priority to Chinese Patent Application No. 202110164107X, filed on Feb. 5, 2021, the contents of which are hereby incorporated by reference.

### TECHNICAL FIELD

The application relates to a point cloud polar coordinate coding method and a device.

### BACKGROUND

Lidar is widely used in the field of self-driving automobiles. Different from conventional image data, the point cloud data collected by lidar has a natural irregular data form, so it is impossible to directly transfer the conventional image target detection algorithm to the point cloud. Therefore, it is one of the main research focuses in the field of point cloud target detection to make the unordered point cloud data orderly by coding and then to use the conventional target detection algorithm to process, which is able to give consideration to both engineering implementation and final effects. In order to achieve a high frame rate, most point cloud data are encoded by a voxel method. However, the current voxel method is based on Cartesian coordinate system, which is different from a way of lidar rotating to collect data, so more inherent characteristics of point cloud data will be lost in the encoding process.

### SUMMARY

The objective of the application is to provide a point cloud polar coordinate coding method and a device aiming at the shortcomings of the prior art, which is able to realize an ordered coding of the point cloud data, at the same time, preserve the intrinsic characteristics of the point cloud data to the maximum extent, and improve the accuracy of subsequent point cloud target detection.

The application is realized by the following technical scheme.

The application relates to a point cloud polar coordinate coding method, and the point cloud polar coordinate coding method is used for coding point cloud data scanned by a lidar and includes following steps:

A, dividing a circular scanning area scanned by a lidar at an equal angle with an angle Δθ to obtain a plurality of identical polar coordinate areas;

B, dividing each of the polar coordinate areas with equal length along a radial direction with a length Δr to obtain a plurality of polar coordinate grids, where a radius interval of a (m, n)th polar coordinate grid is [n*Δr, (n+1)*Δr], and a radian interval is [m*Δθ, (m+1)*Δθ], and generating a plurality of polar coordinate cylinders corresponding to each of the polar coordinate grids in a three-dimensional space;

C, converting all point cloud data in the scanning area into polar coordinates (r, θ), and determining polar coordinate cylinders of the point cloud data according to the radius and radian intervals of the polar coordinate grids where the polar coordinates (r, θ) are located, to obtain polar coordinate cylinder voxels;

D, extracting structural features (r, θ, z, I, r_{c}, θ_{c}, z_{c}, rₚ, θₚ) from the all point cloud data in each of the polar coordinate cylinder voxels, and ensuring that a number of point cloud data in each of the polar coordinate cylinder voxels is L, thus obtaining a tensor with the shape of (M, N, L, 9), where (r, θ, z) are polar coordinates and a height of the point cloud data, I is an intensity of the point cloud data, (r_{c}, θ_{c}, z_{c}) is an offset of the point cloud data to a cluster center, (rₚ, θₚ) is an offset of the point cloud data to bottom centers of the polar coordinate cylinders, and M×N is a total number of the polar coordinate cylinder voxels;

E, performing 1×1 convolution operations on K polar coordinate cylinder voxels containing the point cloud data to obtain a tensor with a shape of (K, L, C), and maximum-pooling a second dimension of the tensor to obtain a feature tensor with a shape of (K, C), and then mapping K features of the feature tensor back to an original position to obtain a two-dimensional point cloud pseudo-image with a shape of (M, N, C), where C means performing different 1×1 convolution operations for C times, and weighted summation coefficients in the C times of the convolution operations are all different;

F, extracting lines (M-3, M-2, M-1) and lines (0, 1, 2) of the two-dimensional point cloud pseudo-image, and copying the lines (M-3, M-2, M-1) to a front of the line 0 for filling, copying the lines (0, 1, 2) behind the line (M-1) for filling, to obtain a two-dimensional point cloud pseudo-image after boundary compensation; and

G, performing feature extraction on the two-dimensional point cloud pseudo-image after the step F by using convolutional neural networks, and outputting a final feature map.

Optionally, an area within a radius r₁ of the circular scanning area is set as a blank area, and the radius interval of the (m, n)th polar coordinate grid is [n*Δr+r₁ (n+1)*Δr+r₁], and the radian interval is [m*Δθ, (m+1)*Δθ].

Optionally, the Δθ=1.125°.

Optionally, in the step C, the point cloud data in the scanning area is converted into polar coordinates (r, θ) by following formula:

$$\{ \begin{matrix} r = \sqrt{{x}^{2} + {y}^{2}} \\ θ = arccos ( \frac{x}{\sqrt{{x}^{2} + {y}^{2}}} ) , y > 0 \\ θ = 2 π - arccos ( \frac{x}{\sqrt{{x}^{2} + {y}^{2}}} ) , y < 0\end{matrix} ,$$

where (x, y) are coordinates of the point cloud data in a rectangular coordinate system.

Optionally, the L=64.

Optionally, in the step D, in order to ensure that the number of the point cloud data in the each of the polar coordinate cylinder voxels is L, when the number of point cloud data in the polar coordinate cylinder voxels exceeds L, the point cloud data is randomly down-sampled to L, and when the number of the point cloud data in polar coordinate cylinder voxels is less than L, data point 0 is supplemented.

Optionally, r₁=2 meters.

The application is also realized by the following technical scheme.

A point cloud polar coordinate coding device includes:

an ordering module: used for dividing a circular scanning area scanned by a lidar at an equal angle with an angle Δθ to obtain a plurality of identical polar coordinate areas; dividing each of the polar coordinate areas with equal length along a radial direction with a length Δr to obtain a plurality of polar coordinate grids, where a radius interval of a (m, n)th polar coordinate grid is [n*Δr, (n+1)*Δr], and a radian interval is [m*Δθ, (m+1)*Δθ], and generating a plurality of polar coordinate cylinders corresponding to each of the polar coordinate grids in a three-dimensional space;

a voxel generation module: used for converting all point cloud data in the scanning area into polar coordinates (r, θ), and determining polar coordinate cylinders of the point cloud data according to the radius and radian intervals of the polar coordinate grids where the polar coordinates (r, θ) are located, to obtain polar coordinate cylinder voxels;

a feature extraction module: used for extracting structural features (r, θ, z, I, r_{c}, θ_{c}, z_{c}, rₚ, θₚ) from the all point cloud data in each of the polar coordinate cylinder voxels, and ensuring that a number of the point cloud data in the each of the polar coordinate cylinder voxels is L, thus obtaining a tensor with the shape of (M, N, L, 9), where (r, θ, z) are polar coordinates and a height of the point cloud data, I is an intensity of the point cloud data, (r_{c}, θ_{c}, z_{c}) is an offset of the point cloud data to a cluster center, (rₚ, θₚ) is an offset of the point cloud data to bottom centers of the polar coordinate cylinders, and M×N is a total number of the polar coordinate cylinder voxels;

a two-dimensional point cloud pseudo-image generation module: used for performing 1×1 convolution operations on K polar coordinate cylinder voxels containing the point cloud data to obtain a tensor with a shape of (K, L, C), and maximum-pooling a second dimension of the tensor to obtain a feature tensor with a shape of (K, C), and then mapping K features of the feature tensor back to an original position to obtain a two-dimensional point cloud pseudo-image with a shape of (M, N, C), where C means performing different 1×1 convolution operations for C times, and weighted summation coefficients in the C times of the convolution operations are all different;

a two-dimensional point cloud pseudo-image compensation module: used for extracting lines (M-3, M-2, M-1) and lines (0, 1, 2) of the two-dimensional point cloud pseudo-image, and copying the lines (M-3, M-2, M-1) to a front of the line 0 for filling, copying the lines (0, 1, 2) behind the line (M-1) for filling, to obtain a two-dimensional point cloud pseudo-image after boundary compensation; and

a final feature map acquisition module: used for performing feature extraction on the two-dimensional point cloud pseudo-image after compensation by using convolutional neural networks, and outputting a final feature map.

Optionally, an area within a radius r₁ of the circular scanning area is set as a blank area, and the radian interval of the (m, n)th polar coordinate grid is [m*Δθ, (m+1)*Δθ] and the radius interval is [n*Δr+r₁, (n+1)*Δr+r₁].

Optionally, the Δθ=1.125°.

The application has the following beneficial effects.

Firstly, according to the application, the disordered point clouds are ordered by polar coordinate coding, so that point cloud data with inconsistent data lengths is able to be converted into structured data with uniform size, which is convenient for subsequent algorithm model processing. Secondly, the polar coding is able to best fit the data acquisition mode of rotating scanning of the lidar, thus preserving the inherent characteristics of point cloud data. Finally, by copying the lines (M-3, M-2, M-1) of the two-dimensional point cloud pseudo-image to a front of the line 0 for filling, and copying the lines (0, 1, 2) behind the line (M-1) for filling, the boundary compensation of the two-dimensional point cloud pseudo-image is realized, so that the two-dimensional point cloud pseudo-image is continuous in the radian dimension, and the error caused by the edge filling operation in the convolution operation process is reduced, therefore, the application is able to effectively improve effectively improve the accuracy of subsequent point cloud target detection.

### BRIEF DESCRIPTION OF THE DRAWINGS

The present application will be described in further detail with reference to the attached drawings.

FIG. 1 is a flowchart of an encoding method of the present application.

FIG. 2 is a schematic diagram of a division of polar coordinate grids in an encoding method of the present application.

FIG. 3 is a schematic diagram of polar coordinate grids (within a polar coordinate area) of an encoding method of the present application.

### DETAILED DESCRIPTION OF THE EMBODIMENTS

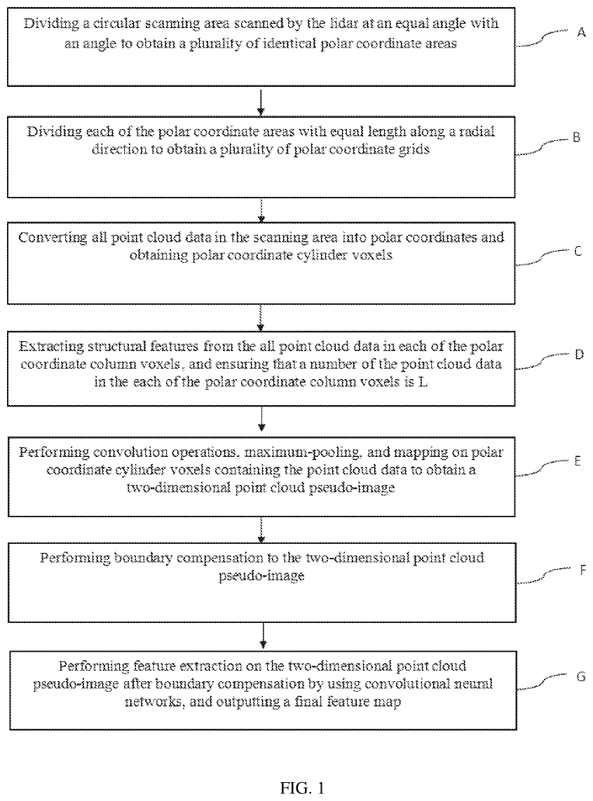

As shown in FIG. 1, a point cloud polar coordinate coding method, which is used for coding point cloud data obtained by a lidar scanning of a vehicle, includes following steps:

A, a circular scanning area scanned by a lidar of the vehicle is divided at an equal angle with an angle Δθ to obtain a plurality of identical polar coordinate areas and an area within a radius r₁ of the circular scanning area is set as a blank area. In this embodiment, the Δθ=1.125°.

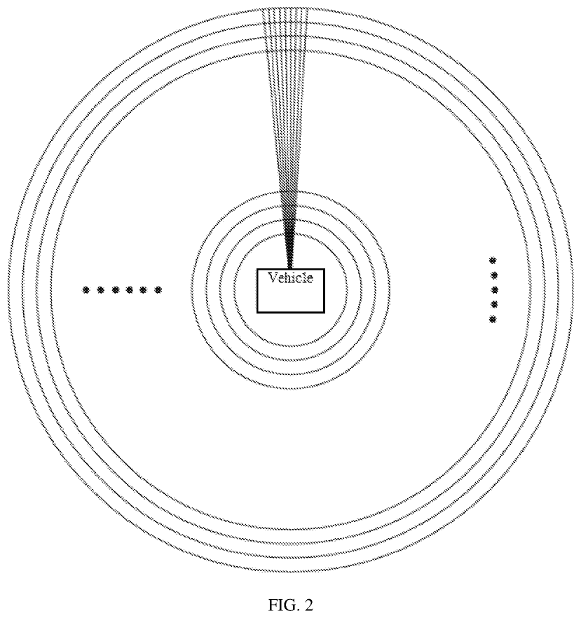

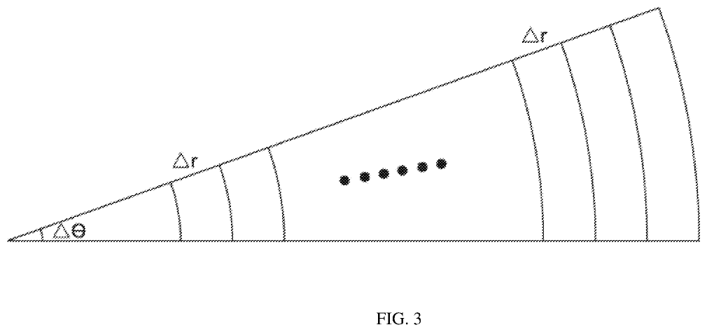

B, each of the polar coordinate areas is divided with equal length along a radial direction with a length Δr to obtain a plurality of polar coordinate grids. A radius interval of a (m, n)th polar coordinate grid is [n*Δr+r₁, (n+1)*Δr+r₁], and a radian interval is [m*Δθ, (m+1)*Δθ], and a plurality of polar coordinate cylinders corresponding to each of the polar coordinate grids are generated in a three-dimensional space, as shown in FIG. 2 and FIG. 3. In this embodiment, r₁=2 meters.

C, all point cloud data in the scanning area is converted into polar coordinates (r, θ), and polar coordinate cylinders of the point cloud data are determined according to the radius and radian intervals of the polar coordinate grids where the polar coordinates (r, θ) are located, to obtain polar coordinate cylinder voxels. A formula for converting into the polar coordinates is

$$\{ \begin{matrix} r = \sqrt{{x}^{2} + {y}^{2}} \\ θ = arccos ( \frac{x}{\sqrt{{x}^{2} + {y}^{2}}} ) , y > 0 \\ θ = 2 π - arccos ( \frac{x}{\sqrt{{x}^{2} + {y}^{2}}} ) , y < 0\end{matrix} ,$$

where (x, y) represent coordinates of the point cloud data in a rectangular coordinate system;

D, structural features (r, θ, z, I, r_{c}, θ_{c}, z_{c}, rₚ, θₚ) are extracted from the all point cloud data in each of the polar coordinate cylinder voxels, and it is ensured that a number of point cloud data in each of the polar coordinate cylinder voxels is L, thus obtaining a tensor with the shape of (M, N, L, 9). The (r, θ, z) are polar coordinates and a height of the point cloud data, I is an intensity of the point cloud data, (r_{c}, θ_{c}, z_{c}) is an offset (the cluster center offset is a center of all point cloud data in polar coordinate cylinder voxels) of the point cloud data to a cluster center, (rₚ, θₚ) is an offset of the point cloud data to bottom centers of the polar coordinate cylinders, and M×N is a total number of the polar coordinate cylinder voxels.

In this embodiment, the L=64.

In order to ensure that the number of the point cloud data in the each of the polar coordinate cylinder voxels is L, when the number of point cloud data in the polar coordinate cylinder voxels exceeds L, the point cloud data is randomly down-sampled to L, and when the number of the point cloud data in polar coordinate cylinder voxels is less than L, data point 0 as structural features is supplemented.

E, because not all polar coordinate cylinder voxels contain point cloud data, 1×1 convolution operations are performed on K polar coordinate cylinder voxels containing the point cloud data to obtain a tensor with the shape of (K, L, C), and a second dimension of the tensor is subjected to a maximum-pooling to obtain a feature tensor with a shape of (K, C), and then K features of the feature tensor are mapped back to an original position to obtain a two-dimensional point cloud pseudo-image with a shape of (M, N, C). The C means performing different 1×1 convolution operations for C times, and weighted summation coefficients in the C convolution operations are all different, so as to further improve the accuracy.

F, after obtaining the two-dimensional point cloud pseudo-image with the shape of (M, N, C), because a first dimension corresponds to a change of the radian of the polar coordinates, there is no boundary in this dimension. In other words, a first line and a last line are connected in space. Therefore, in subsequent convolution operations in this dimension, the pixels out of an edge is not filled with 0 as in the conventional operation, but lines (M-3, M-2, M-1) and lines (0, 1, 2) (that is, the last three lines and the first three lines) of the two-dimensional point cloud pseudo-image are extracted, and the lines (M-3, M-2, M-1) are copied to a front of the line 0 for filling, the lines (0, 1, 2) are copied behind the line (M-1) for filling, to obtain a two-dimensional point cloud pseudo-image (M+6, N, C) after boundary compensation.

G, feature extraction is performed on the two-dimensional point cloud pseudo-image after the step F by using existing neural networks, and a final feature map is output.

A point cloud polar coordinate coding device includes:

an ordering module: used for dividing a circular scanning area scanned by a lidar at an equal angle with an angle Δθ to obtain a plurality of identical polar coordinate areas; dividing each of the polar coordinate areas with equal length along a radial direction with a length Δr to obtain a plurality of polar coordinate grids, where a radius interval of a (m, n)th polar coordinate grid is [n*Δr, (n+1)*Δr], and a radian interval is [m*Δθ, (m+1)*Δθ], and generating a plurality of polar coordinate cylinders corresponding to each of the polar coordinate grids in a three-dimensional space;

a voxel generation module: used for converting all point cloud data in the scanning area into polar coordinates (r, θ), and determining polar coordinate cylinders of the point cloud data according to the radius and radian intervals of the polar coordinate grids where the polar coordinates (r, θ) are located, to obtain polar coordinate cylinder voxels;

a feature extraction module: used for extracting structural features (r, θ, z, I, r_{c}, θ_{c}, z_{c}, rₚ, θₚ) from the all point cloud data in each of the polar coordinate cylinder voxels, and ensuring that a number of the point cloud data in the each of the polar coordinate cylinder voxels is L, thus obtaining a tensor with the shape of (M, N, L, 9), where (r, θ, z) are polar coordinates and a height of the point cloud data, I is an intensity of the point cloud data, (r_{c}, θ_{c}, z_{c}) is an offset of the point cloud data to a cluster center, (rₚ, θₚ) is an offset of the point cloud data to bottom centers of the polar coordinate cylinders, and M×N is a number of the polar coordinate cylinder voxels;

a two-dimensional point cloud pseudo-image generation module: used for performing 1×1 convolution operations on K polar coordinate cylinder voxels containing the point cloud data to obtain a tensor with a shape of (K, L, C), and maximum-pooling a second dimension of the tensor to obtain a feature tensor with a shape of (K, C), and then mapping K features of the feature tensor back to an original position to obtain a two-dimensional point cloud pseudo-image with a shape of (M, N, C), where C means performing different 1×1 convolution operations for C times, and weighted summation coefficients in the C times of the convolution operations are all different;

a two-dimensional point cloud pseudo-image compensation module: used for extracting lines (M-3, M-2, M-1) and lines (0, 1, 2) of the two-dimensional point cloud pseudo-image, and copying the lines (M-3, M-2, M-1) to a front of the line 0 for filling, copying the lines (0, 1, 2) behind the line (M-1) for filling, to obtain a two-dimensional point cloud pseudo-image after boundary compensation; and

a final feature map acquisition module: used for performing feature extraction on the two-dimensional point cloud pseudo-image after compensation by using convolutional neural networks, and outputting a final feature map.

The above is only the preferred embodiments of the present application, so it cannot be used to limit the scope of implementation of the present application, and equivalent changes and modifications made according to the scope of the patent application and the contents of the specification should still fall within the scope of the present application.

What is claimed is:

1. A point cloud polar coordinate coding method used for coding point cloud data scanned by a lidar, comprising following steps:
A, dividing a circular scanning area scanned by the lidar at an equal angle with an angle Δθ to obtain a plurality of identical polar coordinate areas;
B, dividing each of the polar coordinate areas with an equal length along a radial direction with a length Δr to obtain a plurality of polar coordinate grids, wherein a radius interval of a (m, n)th polar coordinate grid is [n*Δr, (n+1)*Δr], and a radian interval is [m*Δθ, (m+1)*Δθ], and generating a plurality of polar coordinate cylinders corresponding to each of the polar coordinate grids in a three-dimensional space;
C, converting all point cloud data in the scanning area into polar coordinates (r, θ), and determining the polar coordinate cylinders of the point cloud data according to the radius and radian intervals of the polar coordinate grids of the polar coordinates (r, θ), to obtain polar coordinate cylinder voxels;
D, extracting structural features (r, θ, z, I, r_{c}, θ_{c}, z_{c}, rₚ, θₚ) from the all point cloud data in each of the polar coordinate cylinder voxels, and ensuring that a number of the point cloud data in the each of the polar coordinate cylinder voxels is L to obtain a tensor with a shape of (M, N, L, 9), wherein (r, θ, z) are polar coordinates and a height of the point cloud data, I is an intensity of the point cloud data, (r_{c}, θ_{c}, z_{c}) is an offset of the point cloud data to a cluster center, (rₚ, θₚ) is an offset of the point cloud data to bottom centers of the polar coordinate cylinders, and M×N is a total number of the polar coordinate cylinder voxels;
E, performing 1×1 convolution operations on K polar coordinate cylinder voxels containing the point cloud data to obtain a tensor with a shape of (K, L, C), and maximum-pooling a second dimension of the tensor to obtain a feature tensor with a shape of (K, C), and then mapping K features of the feature tensor back to an original position to obtain a two-dimensional point cloud pseudo-image with a shape of (M, N, C), wherein C means performing different 1×1 convolution operations for C times, and weighted summation coefficients in the C times of the convolution operations are all different;
F, extracting a (M-3, M-2, M-1)th line and a (0, 1, 2)th line of the two-dimensional point cloud pseudo-image, and copying the (M-3, M-2, M-1)th line to a front of a line 0 for filling, copying the (0, 1, 2)th line behind a (M-1)th line for filling, to obtain a two-dimensional point cloud pseudo-image after boundary compensation; and
G, performing feature extraction on the two-dimensional point cloud pseudo-image after the step F by using convolutional neural networks, and outputting a final feature map.

2. The point cloud polar coordinate coding method according to claim 1, wherein an area within a radius r₁ of the circular scanning area is set as a blank area, and the radius interval of the (m, n)th polar coordinate grid is [n*Δr+r₁, (n+1)*Δr+r₁], and the radian interval is [m*Δθ, (m+1)*Δθ].

3. The point cloud polar coordinate coding method according to claim 1, wherein the Δθ=1.125°.

4. The point cloud polar coordinate coding method according to claim 1, wherein in the step C, the point cloud data in the scanning area is converted into polar coordinates (r, θ) by a following formula:
$$\{ \begin{matrix} r = \sqrt{{x}^{2} + {y}^{2}} \\ θ = arccos ( \frac{x}{\sqrt{{x}^{2} + {y}^{2}}} ) , y > 0 \\ θ = 2 π - arccos ( \frac{x}{\sqrt{{x}^{2} + {y}^{2}}} ) , y < 0\end{matrix} ,$$
wherein (x, y) are coordinates of the point cloud data in a rectangular coordinate system.

5. The point cloud polar coordinate coding method according to claim 1, wherein the L=64.

6. The point cloud polar coordinate coding method according to claim 1, wherein in the step D, in order to ensure that the number of the point cloud data in the each of the polar coordinate cylinder voxels is L, when the number of point cloud data in the polar coordinate cylinder voxels exceeds L, the point cloud data is randomly down-sampled to L, and when the number of the point cloud data in the polar coordinate cylinder voxels is less than L, data point 0 is supplemented.

7. The point cloud polar coordinate coding method according to claim 2, wherein the r₁=2 meters.

8. A point cloud polar coordinate coding device, comprising:
an ordering module: used for dividing a circular scanning area scanned by a lidar at an equal angle with an angle Δθ to obtain a plurality of identical polar coordinate areas; dividing each of the polar coordinate areas with an equal length along a radial direction with a length Δr to obtain a plurality of polar coordinate grids, wherein a radius interval of a (m, n)th polar coordinate grid is [n*Δr, (n+1)*Δr], and a radian interval is [m*Δθ, (m+1)*Δθ], and generating a plurality of polar coordinate cylinders corresponding to each of the polar coordinate grids in a three-dimensional space;
a voxel generation module: used for converting all point cloud data in the scanning area into polar coordinates (r, θ), and determining the polar coordinate cylinders of the point cloud data according to the radius and radian intervals of the polar coordinate grids of the polar coordinates (r, θ), to obtain polar coordinate cylinder voxels;
a feature extraction module: used for extracting structural features (r, θ, z, I, r_{c}, θ_{c}, z_{c}, rₚ, θₚ) from the all point cloud data in each of the polar coordinate cylinder voxels, and ensuring a number of the point cloud data in the each of the polar coordinate cylinder voxels is L to obtain a tensor with a shape of (M, N, L, 9), wherein (r, θ, z) are polar coordinates and a height of the point cloud data, I is an intensity of the point cloud data, (r_{c}, θ_{c}, z_{c}) is an offset of the point cloud data to a cluster center, (rₚ, θₚ) is an offset of the point cloud data to bottom centers of the polar coordinate cylinders, and M×N is a number of the polar coordinate cylinder voxels;
a two-dimensional point cloud pseudo-image generation module: used for performing 1×1 convolution operations on K polar coordinate cylinder voxels containing the point cloud data to obtain a tensor with a shape of (K, L, C), and maximum-pooling a second dimension of the tensor to obtain a feature tensor with a shape of (K, C), and then mapping K features of the feature tensor back to an original position to obtain a two-dimensional point cloud pseudo-image with a shape of (M, N, C), wherein C means performing different 1×1 convolution operations for C times, and weighted summation coefficients in the C times of the convolution operations are all different;
a two-dimensional point cloud pseudo-image compensation module: used for extracting lines (M-3, M-2, M-1) and lines (0, 1, 2) of the two-dimensional point cloud pseudo-image, and copying a(M-3, M-2, M-1)th line to a front of a line 0 for filling, copying a (0, 1, 2)th line behind a (M-1)th line for filling, to obtain a two-dimensional point cloud pseudo-image after boundary compensation; and
a final feature map acquisition module: used for performing feature extraction on the two-dimensional point cloud pseudo-image after compensation by using convolutional neural networks, and outputting a final feature map.

9. The point cloud polar coordinate coding device according to claim 8, wherein an area within a radius r₁ of the circular scanning area is set as a blank area, and the radian interval of the (m, n)th polar coordinate grid is [m*Δθ, (m+1)*Δθ] and the radius interval is [n*Δr+r₁, (n+1)*Δr+r₁].

10. The point cloud polar coordinate coding device according to claim 8, wherein the Δθ=1.125°.
